(19) United States
(12) Patent Application Publication
(10) Pub. No.: US 2025/0342441 A1
(43) Pub. Date: Nov. 6, 2025

(54) AI-Generated Video Newscast Platform for Workplace Communication and Related Methods

(71) Applicants: Albert Hernandez, Chino Hills, CA (US); Jonathan Beltran, Chino Hills, CA (US)

(72) Inventors: Albert Hernandez, Chino Hills, CA (US); Jonathan Beltran, Chino Hills, CA (US)

(73) Assignee: IQSpark LLC, Chino Hills, CA (US)

(21) Appl. No.: 19/075,684

(22) Filed: Mar. 10, 2025

(51) Int. Cl. G06Q 10/10; G06F 40/205; G06F 40/295; G06F 40/35; G06T 13/20; G06T 13/40; G10L 13/033

(52) U.S. Cl. CPC G06Q 10/10; G06F 40/205; G06F 40/295; G06F 40/35; G06T 13/205; G06T 13/40; G10L 13/033; G06T 2200/24

(57) ABSTRACT

The invention relates to a digital communication tool and a method for transforming professional communication. The tool and method involve creating streamlined, engaging multimedia content using various information sources such as electronic communication, task coordination software, online social platforms, and online platforms. The multimedia content is presented using digital personas and includes brief, customisable multimedia clips. The tool and method also offer context-specific digital environments and utilise recorded meeting content, instant communication tools, and written records as workplace information sources.

### CROSS-REFERENCES

This application claims the benefit of U.S. Provisional Application No. 63/564,508, filed on Mar. 13, 2024, which is incorporated herein by reference in its entirety.

This application is also related to U.S. patent application Ser. No. 19/048,942, filed on Feb. 9, 2025, titled “AI-Based Audio Digest System and Related Methods”, which is incorporated herein by reference in its entirety. The present invention expands upon the concepts described in the related application by introducing an AI-generated video-based summarization system utilizing digital avatars to present workplace updates in an engaging, multimedia format.

### BACKGROUND OF THE INVENTION

In the modern workplace, professionals are often inundated with a plethora of information from various sources such as emails, project management tools, social media, and other digital platforms. This information overload can lead to inefficiencies, as individuals may struggle to sift through extensive emails or documents to stay informed about their workplace developments. Furthermore, traditional text-based updates may not be the most engaging or efficient way to consume information. There is also a challenge in ensuring that the information is personalized and relevant to the individual's context and preferences. Additionally, fostering a connected and informed team environment can be a challenge when information is not easily accessible or digestible. Therefore, there is a need for a more efficient and engaging way to deliver workplace updates.

### SUMMARY OF THE INVENTION

In accordance with embodiments, a digital communication tool is provided for transforming professional communication. The tool creates streamlined, engaging multimedia content using various information sources such as electronic communication, task coordination software, online social platforms, and online platforms. The multimedia content is presented using digital personas and includes brief, customizable multimedia clips. The tool also offers context-specific digital environments and utilizes recorded meeting content, instant communication tools, and written records as workplace information sources. In accordance with other embodiments, a method is provided for transforming professional communication. The method involves creating customized, streamlined, engaging multimedia content using various information sources such as electronic communication, task coordination software, online social platforms, and online platforms. The multimedia content is presented using digital personas and includes brief, customizable multimedia clips. The method also offers context-specific digital environments and utilizes recorded meeting content, instant communication tools, and written records as workplace information sources.

### TECHNICAL FIELD OF THE INVENTION

The invention pertains to a communication platform that transforms workplace updates into personalized video newscasts using AI technology.

### BRIEF DESCRIPTION OF THE FIGURES

FIG. 1 illustrates, in a flowchart, operations for creating and presenting customised multimedia content in accordance with certain embodiments.

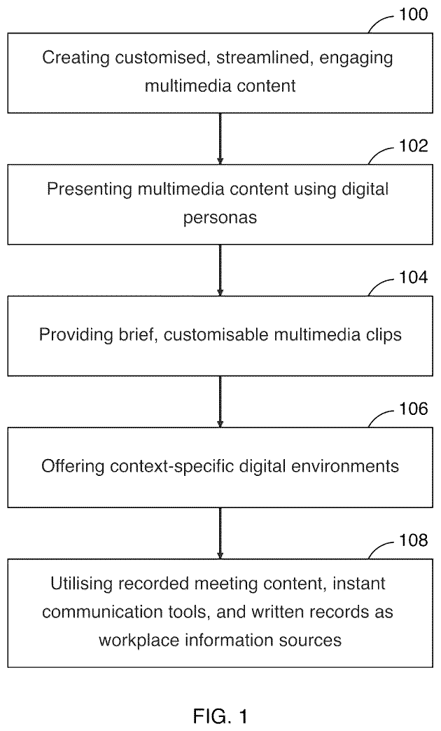

FIG. 1A illustrates, in a flowchart, operations for creating multimedia content using various electronic communication and online platforms.

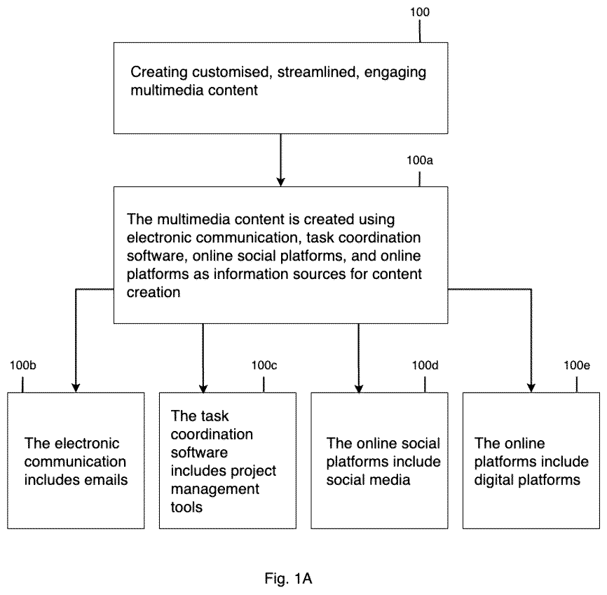

FIG. 1B illustrates, in a flowchart, operations for presenting the multimedia content using digital personas.

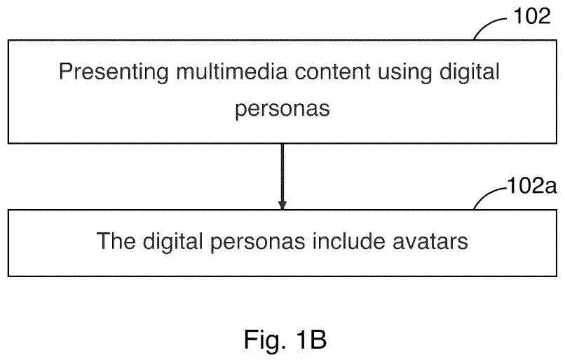

FIG. 1C illustrates, in a flowchart, operations for providing brief, customisable multimedia clips.

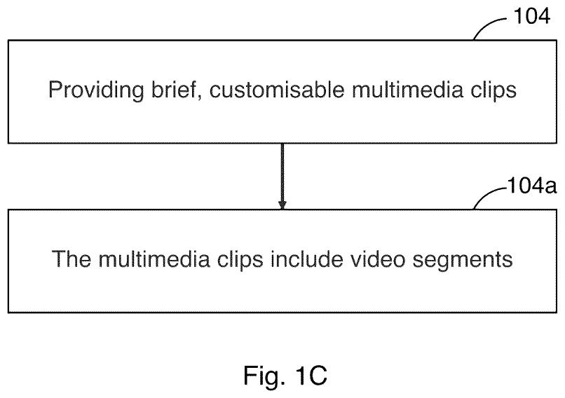

FIG. 1D illustrates, in a flowchart, operations for offering context-specific digital environments.

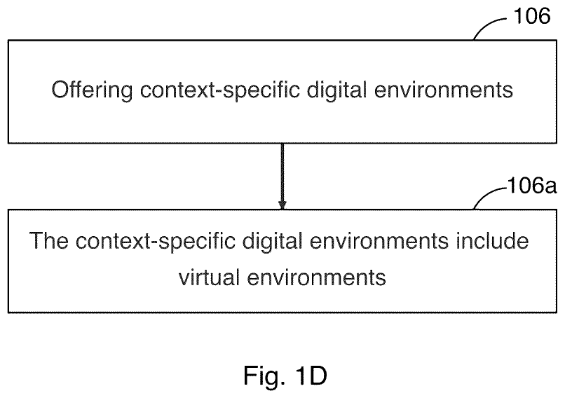

FIG. 1E illustrates, in a flowchart, operations for utilising various workplace information sources for content creation.

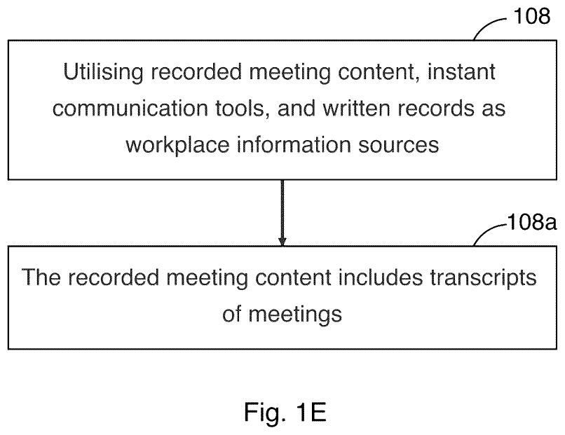

FIG. 2 illustrates, in a block diagram, the structure of the AI-Generated Video Newscast System and its main component.

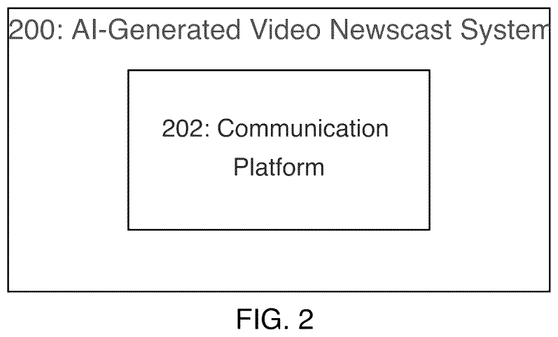

FIG. 2A illustrates, in a block diagram, the ‘Information Gathering’ sub-component of the ‘Communication Platform’.

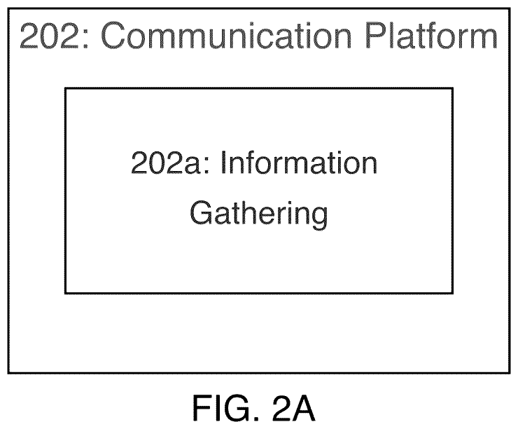

FIG. 2B illustrates, in a block diagram, the ‘Content Delivery’ sub-component of the ‘Communication Platform’.

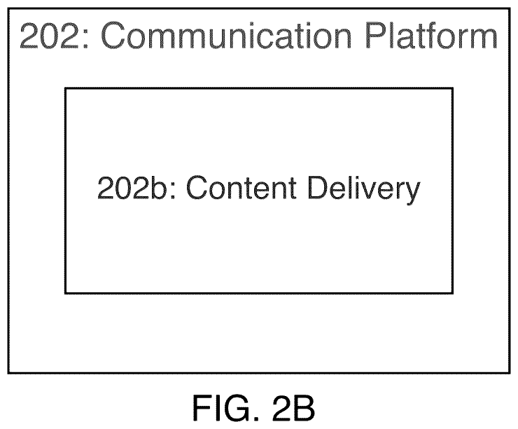

FIG. 2C illustrates, in a block diagram, the ‘Workplace Data Utilization’ sub-component of the ‘Communication Platform’.

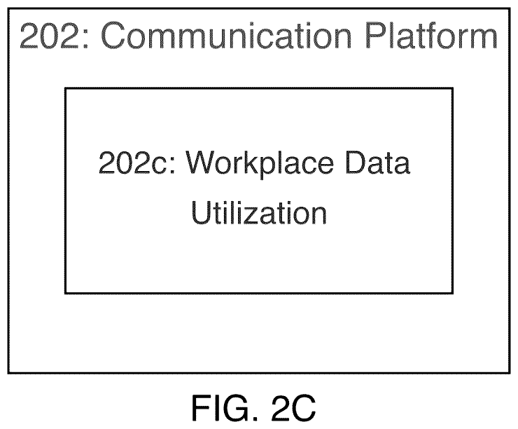

### DETAILED DESCRIPTION

The system and methods described herein build upon related technology disclosed in U.S. patent application Ser. No. 19/048,942, which describes an AI-driven system for generating audio-based summaries of workplace communications. The present invention expands upon this approach by incorporating video-based presentations using digital avatars to enhance engagement and comprehension.

Step 100 involves the process of synthesizing information into a multimedia format. This step includes the use of algorithms to analyze data and software to facilitate the creation of content such as video segments. The objective is to produce content that is informative and engaging, allowing professionals to consume workplace updates efficiently. Sub-step 100-a specifies the sources from which information is gathered to create the multimedia content. This includes data from electronic communication, task coordination software, online social platforms, and online platforms. Tools designed for data extraction mine information from these sources with the purpose of gathering relevant data to be synthesized into the multimedia content. Sub-steps 100-b, 100-c, 100-d, and 100-e define the specific types of information sources used. These sub-steps involve scanning, filtering, and analyzing content from emails, project management tools, social media, and digital platforms to extract pertinent information. Tools and processes are designed to interface with each type of platform to ensure that the content is relevant and personalized to the user's context. In practice, these steps involve software processes that collect and process data from various digital communication channels. Tools use natural language processing and machine learning to understand the context and significance of the information. Content creation software then uses this processed data to generate video segments that are presented by digital figures in virtual environments. The objective of these steps is to streamline the flow of information and enhance the experience by providing an efficient way to stay informed about workplace developments. Step 102 involves the presentation of multimedia content through the use of digital personas. This step is further detailed in sub-step 102-a, which specifies that these digital personas are avatars. In practical terms, step 102 encompasses the deployment of avatars to deliver video newscasts. These avatars act as the visual representatives of the communication, providing a human-like interface for the information being conveyed. The avatars can be representations of known personalities or figures generated through artificial intelligence, serving as news presenters within a virtual setting. The use of avatars aims to create an engaging experience for the user, offering a visual element in contrast to text or audio-only updates. The avatars described in step 102-a are graphical representations that perform the task of content delivery. They are crafted to simulate human expressions and movements to enhance the interaction. The development of these avatars involves graphic design and animation, with the potential inclusion of motion capture technology to achieve realistic movements. Users have the ability to select an avatar that aligns with their preferences or the context of the content. The process encapsulated by step 102 includes several stages. Initially, content is aggregated from various sources such as emails, project management tools, social media, and digital platforms (step 100-a). This content is then processed into a condensed script for the avatar to present. The script is designed to communicate the essential information succinctly. The avatar presents this script as a video segment within a virtual environment (step 106-a) that is chosen to complement the content and enhance the message. In essence, step 102 and sub-step 102-a describe the process of using avatars to present synthesized workplace information as video newscasts. This involves content curation driven by artificial intelligence, the design and animation of avatars, and the use of virtual environments to deliver a personalized and contextually appropriate experience for the user. Step 104 involves the generation of video segments that are designed to convey workplace information succinctly. This step includes the transformation of textual content into a visual and auditory format. The process begins with the aggregation of content from various sources, such as emails, project management tools, social media, and digital platforms (Step 100-a). Algorithms analyze this data to identify relevant information. Following data aggregation, the system processes the content to extract key points, creating a script that encapsulates the essential messages. This involves natural language processing techniques to distill the text into a more concise form. Users are provided with options to customize the video segments. This customization could involve selecting topics, determining the length of the video, and setting other parameters that align the content with the user's preferences. The creation of the video segment is the next step, where the script is converted into an audiovisual format. This includes the use of text-to-speech technology for narration and the incorporation of visual elements to support the narrative. Finally, the completed video segment is delivered to the user through the platform. The delivery mechanism is designed to be compatible with various devices and platforms, ensuring accessibility according to the user's specified preferences for receiving updates. Throughout this process, algorithms perform data extraction and content analysis; the user interface facilitates customization; and multimedia content creation tools produce the video segments. The objective is to provide a method for professionals to receive information in a format that is easy to digest, without the need to sift through large amounts of text. Step 106 involves the provision of digital environments that are specific to the context of the content being presented in video newscasts. These digital environments are designed using computer graphics and 3D modeling software. The individuals responsible for creating these environments use these tools to produce a variety of settings that can be utilized within the video newscasts to complement the information being conveyed. The digital environments can vary from simple backgrounds to complex scenes that resemble real-life locations. The selection of a particular environment is determined by the subject matter of the newscast. For instance, a financial update might be set against a backdrop that resembles a business setting, while a team update might use a more relaxed scene. The process includes a mechanism for users to select their preferred environment or for the system to automatically suggest environments that match the content's theme. This mechanism is part of the user interface of the platform. Once selected, these digital environments are integrated into the video production process, where avatars present the newscasts against these backdrops. In summary, Step 106 encompasses the design, selection, and integration of digital environments that match the theme of the video newscasts, aiming to enhance the experience by providing a visually relevant setting for the information being presented. Step 108 involves the process of gathering data from various workplace communication tools for the purpose of content creation. This step includes the extraction and analysis of transcripts from meetings (108-a), messages from instant communication applications, and information from written records. In step 108-a, the system parses text from meeting transcripts to identify key points and summarize the content. This requires natural language processing techniques to understand the context and extract meaningful information. For messages from instant communication tools, the system connects to various messaging APIs, retrieves messages, and applies natural language processing to filter and summarize conversations that should be highlighted in the video newscasts. For written records, the system analyzes documents, which could involve optical character recognition if the documents are scanned images, followed by natural language processing to extract and condense the information into a format suitable for video content. The system uses software modules designed to interface with these data sources. These modules authenticate with the data sources, retrieve the necessary information, and process it using algorithms. The system determines what content is relevant by learning from user interactions, feedback, and predefined preferences. The processed data is then used to generate scripts for the video newscasts, which are presented by avatars in virtual environments as described in step 106-a. The algorithms are responsible for understanding, summarizing, and personalizing the content. The data sources provide the raw information that needs to be communicated, and the processing modules act as the bridge between the raw data and the algorithms. The AI-Generated Video Newscast System (200) is designed to transform workplace communication by synthesizing information into personalized video updates. The system includes a Communication Platform (202) that facilitates professional engagement through the use of Information Gathering (202-a), Content Delivery (202-b), and Workplace Data Utilization (202-c). The Information Gathering (202-a) module aggregates content from various sources such as emails, project management tools, social media, and digital platforms. This module systematically collects information to provide a comprehensive view of workplace updates. The Content Delivery (202-b) module then processes this information using algorithms to generate multimedia content. Digital avatars are used to present this content, which can be customized to suit viewer preferences. The content is presented in video format and is designed to be concise and relevant to the viewer's needs. The Workplace Data Utilization (202-c) module processes recorded meeting content, instant messaging communications, and written documents to extract key points and insights. This module ensures that significant information from workplace communications is captured and presented in an accessible format through video segments. The system's structured approach, from content collection to delivery, aims to keep professionals informed efficiently, supporting an informed and connected organizational environment. The Communication Platform (202) serves as a digital tool to transform professional engagement through AI-generated video newscasts, which facilitate the consumption of workplace information. This platform is composed of Information Gathering (202-a), Content Delivery (202-b), and Workplace Data Utilization (202-c). Information Gathering (202-a) aggregates content from various digital sources such as emails, project management tools, social media, and other online platforms. This aggregation ensures that the content reflects the diverse nature of workplace communication. Content Delivery (202-b) utilizes digital personas, or avatars, to present the aggregated information in a multimedia format. These avatars act as news presenters, delivering the content in video segments that are designed to convey information efficiently. The digital environments where these avatars operate are selected to match the content's context, aiding in the viewer's understanding. Workplace Data Utilization (202-c) incorporates recorded meeting content, instant communication tools, and written records into the newscasts. This integration provides a narrative that is based on actual workplace data and discussions. The combination of these sub-components delivers a communication experience that is tailored to the needs of professionals, ensuring that they receive relevant and concise information.

1. A computer-implemented workplace communication system for generating personalized video newscasts from workplace information, comprising:
a. A multi-source content aggregation module configured to continuously collect and filter workplace communications from structured and unstructured data sources, including emails, project management platforms, instant messaging applications, social networks, meeting transcripts obtained via speech-to-text processing, and real-time event logs from enterprise software tools accessed through APIs;
b. An AI-driven content processing and ranking engine that:
i. Assigns weighted relevance scores to the collected data by analyzing the content using natural language processing (NLP) and machine learning models,
ii. Extracts key entities, action items, and topics to generate structured summaries,
iii. Detects the emotional tone and urgency of communications via sentiment analysis, iv. Incorporates user-specific behavioral patterns, communication frequency, and historical preferences to dynamically tailor content ranking;
c. A contextualized avatar-based presentation module that:
i. Generates a videonewscast using a digital avatar presenter,
ii. Dynamically adjusts facial expressions, speech patterns, and gestures of the avatar based on content tone and sentiment analysis,
iii. Uses AI-based voice synthesis with real-time adaptive intonation
iv. Provides a context-aware virtual background corresponding to the nature of the summarized content;
d. A user customization interface that:
i. Allows each user to configure content priorities, adjust delivery frequency, and select avatar characteristics including voice style, appearance, and formality level,
ii. Enables multi-modal content consumption through video, audio-only, and text-based summaries;
e. A machine-learning adaptive feedback mechanism that:
i. Continuously refines future content selection and presentation format based on user engagement metrics, including watch time, interaction behavior, and skip patterns,
ii. Predicts content fatigue and dynamically adjusts the prioritization and rotation of workplace updates to avoid redundant information delivery,
iii. Generates interactive post-newscast engagement elements such as quizzes or real-time user inquiries to assess comprehension and relevance.

2. The system of claim 1, wherein the multi-source content aggregation module applies graph-based clustering algorithms to detect duplicate or redundant updates across different workplace communication channels and automatically consolidates similar content before presentation.

3. The system of claim 1, wherein the AI-driven content processing and ranking engine integrates named entity recognition (NER) and dependency parsing techniques to identify organizational hierarchies and tailor information relevance based on the user's job role and project involvement.

4. The system of claim 1, wherein the avatar-based presentation module dynamically synchronizes lip movements, facial expressions, and gestural emphasis using a neural network trained on contextual speech and motion data.

5. The system of claim 1, wherein the user customization interface enables multi-lingual avatar presentation, providing real-time voice cloning and lip-synced translations of the newscast in the user's preferred language.

6. The system of claim 1, wherein the machine-learning adaptive feedback mechanism incorporates reinforcement learning models to optimize content delivery schedules based on historical engagement trends and real-time workforce priorities.

7. The system of claim 1, further comprising an enterprise integration module that allows the system to securely access and summarize privileged or classified workplace information using role-based authentication and differential access controls.

8. The system of claim 1, wherein the AI-driven content processing and ranking engine assigns different priority weights to workplace communications based on the user's organizational role, project involvement, and past engagement behavior.

9. The system of claim 1, wherein the machine-learning adaptive feedback mechanism dynamically adjusts the timing and frequency of newscast updates based on user engagement patterns and the predicted importance of upcoming workplace events.

10. A computer-implemented method for transforming workplace communication into an AI-generated video newscast, the method comprising:
a. Aggregating workplace data from a plurality of sources, including emails, project management software, instant messaging platforms, meeting transcripts, and enterprise digital records;
b. Filtering and prioritizing the aggregated data using artificial intelligence by:
i. Extracting key entities, action items, and deadlines using NLP,
ii. Assessing the emotional tone and urgency of messages via sentiment analysis,
iii. Dynamically adjusting the ranking of updates based on user-specific priorities and behavioral insights;
c. Generating a video summary of the prioritized updates by:
i. Converting the structured summary into a narration script,
ii. Synthesizing speech for a digital avatar newscaster to deliver the content with synchronized facial expressions and lip movements,
iii. Selecting an AI-generated virtual background corresponding to the update category;
d. Delivering the AI-generated video newscast to users through at least one digital channel selected from a mobile application, a corporate dashboard, or an enterprise messaging platform, wherein the newscast is dynamically formatted based on the user's preferences;
e. Refining subsequent newscasts by analyzing real-time user engagement data and feedback using machine learning, thereby optimizing future content selection, avatar presentation style, and delivery timing.

11. The method of claim 10, wherein the filtering and prioritization process dynamically segments workplace updates into contextual categories using hierarchical topic classification and predictive analytics.

12. The method of claim 10, wherein the avatar's speech tone, speed, and expressive gestures are modulated based on the urgency level of each workplace update.

13. The method of claim 10, wherein interactive engagement components such as real-time Q&A, knowledge retention quizzes, or poll-based user feedback mechanisms are embedded in the video newscast.

14. The method of claim 10, wherein redundant or repetitive information is automatically suppressed or merged based on cross-referencing historical communication logs.

15. The method of claim 10, wherein user engagement metrics are used to forecast content consumption fatigue and dynamically adjust the mix of information topics to maintain user engagement.
